(19) United States
(12) Patent Application Publication
(10) Pub. No.: US 2024/0015673 A1
(43) Pub. Date: Jan. 11, 2024

(54) Control Of Signal Transmission Between Communication Devices

(71) Applicant: Axiom Technologies LLC, Reston, VA (US)

(72) Inventor: Maxwell DOHERTY, Reston, VA (US)

(73) Assignee: Axiom Technologies LLC, Reston, VA (US)

(21) Appl. No.: 18/218,660

(22) Filed: Jul. 6, 2023

Related U.S. Application Data
(60) Provisional application No. 63/359,033, filed on Jul. 7, 2022.

(51) Int. Cl. H04W 56/00; H04W 72/0453

(52) U.S. Cl. CPC H04W 56/001; H04W 72/0453

(57) ABSTRACT

A system for synchronizing communication between devices includes a first cellular network antenna, and a second cellular network antenna in communication with the first cellular network antenna via a cellular network, each of the first cellular network antenna and the second cellular network antenna configured to broadcast outbound signals. The system includes a first communication device configured to receive outbound signals broadcast by the first cellular network antenna, and a second communication device configured to receive outbound signals broadcast by the second cellular network antenna, the first communication device and the second communication device configured to synchronize communication between one another according to at least one parameter of the received outbound signals.

### CROSS-REFERENCE TO RELATED APPLICATIONS

This application claims the benefit of U.S. Provisional Application No. 63/359,033, filed on Jul. 7, 2022. The entire disclosure of the above application is incorporated herein by reference.

### FIELD

The present disclosure relates to systems and methods for control of signal transmission between communication devices.

### SUMMARY

A system for synchronizing communication between devices includes a first cellular network antenna, and a second cellular network antenna in communication with the first cellular network antenna via a cellular network, each of the first cellular network antenna and the second cellular network antenna configured to broadcast outbound signals. The system includes a first communication device configured to receive outbound signals broadcast by the first cellular network antenna, and a second communication device configured to receive outbound signals broadcast by the second cellular network antenna, the first communication device and the second communication device configured to synchronize communication between one another according to at least one parameter of the received outbound signals.

In other features, each of the first cellular network antenna and the second cellular network antenna is not configured to receive signals from the first communication device and the second communication device. In other features, the first communication device and the second communication device are configured to communicate with one another over a channel which is separate from the cellular network.

In other features, the at least one parameter of outbound signals broadcast by the first cellular network antenna is in synchronization with the at least one parameter of outbound signals broadcast by the second cellular network antenna. In other features, the first cellular network antenna includes a self-synchronized transmitter, and the second cellular network antenna includes a self-synchronized transmitter.

In other features, the first cellular network antenna is a 5G cellular network antenna, the second cellular network antenna is a 5G cellular network antenna, and the cellular network is a 5G cellular network. In other features, the first communication device is configured to set an internal synchronization parameter of the first communication device, for communication with the second communication device, according to the at least one parameter of the received outbound signals, and the second communication device is configured to set an internal synchronization parameter of the second communication device, for communication with the first communication device, according to the at least one parameter of the received outbound signals.

In other features, the internal synchronization parameter of the first communication device is a communication frequency parameter for communication with the second communication device. In other features, the internal synchronization parameter of the first communication device is a communication time parameter for communication with the second communication device.

In other features, the first communication device is configured to survey of a radio frequency (RF) environment of the first communication device to create an RF environment map of the first communication device. In other features, the first communication device is configured to identify at least one channel of interest according to at least one of an existing signal type of each channel in the RF environment map or an emptiness of each channel in the RF environment map. In other features, the first communication device is configured to transmit the RF environment map to the second communication device.

In other features, the second communication device is configured to determine at least one optimal transmit channel or receive channel for communication between the first communication device and the second communication device. In other features, the first communication device is configured to perform at least one waveform encryption method for communicating with the second communication device. In other features, the at least one waveform encryption method includes at least one of an out-of-band key exchange, a pre-shared key exchange, or in-band key rolling.

A method for synchronizing communication between devices includes broadcasting outbound signals by a first network antenna, broadcasting outbound signals by a second network antenna in communication with the first network antenna, receiving, by a first communication device, outbound signals broadcast by the first network antenna, receiving, by a second communication device, outbound signals broadcast by the second network antenna, and synchronizing communication between the first communication device and the second communication device according to at least one parameter of the received outbound signals.

In other features, synchronizing communication includes communicating between the first communication device and the second communication device over a channel which is separate from a communication network for communication between the first network antenna and the second network antenna. In other features, the at least one parameter of outbound signals broadcast by the first network antenna is in synchronization with the at least one parameter of outbound signals broadcast by the second network antenna.

In other features, the method includes setting an internal synchronization parameter of the first communication device, for communication with the second communication device, according to the at least one parameter of the received outbound signals, and setting an internal synchronization parameter of the second communication device, for communication with the first communication device, according to the at least one parameter of the received outbound signals. In other features, the internal synchronization parameter of the first communication device is a communication frequency parameter or a communication time parameter for communication with the second communication device.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a functional block diagram of an example communication device.

FIG. 2 is a functional block diagram of an example system including multiple communication devices in communication with one another.

FIG. 3 is flowchart depicting an example process for synchronizing communication between two communication devices.

FIG. 4 is a flowchart depicting an example process for mapping a signal environment of a communication device.

In the drawings, reference numbers may be reused to identify similar and/or identical elements.

### DETAILED DESCRIPTION

In various implementations, systems and method are disclosed for controlling one or more aspects of signal transmission between communication devices. For example, time and parameter synchronization between distant devices may be implemented using multiple non-cooperative, self-synchronized transmitters.

In some example embodiments, synchronization may be implemented using passive observation of signals from other devices or systems, passively receiving data from other devices or systems, etc. For example, communication devices may implement synchronization using data that is normally transmitted to other User Equipment (UE) as active subscriber data.

Any suitable synchronization may be implemented for signal transmission, including time synchronization, frequency synchronization, etc. In various implementations, multiple communication devices may cooperate to create a map of a signal environment, and share the map between node that are attempting to synchronize with one another.

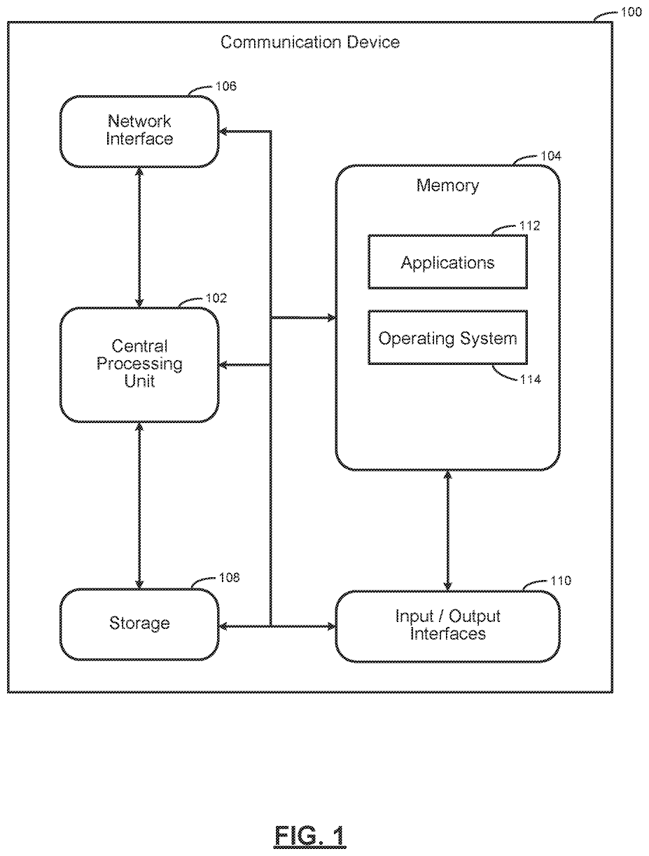

FIG. 1 illustrates an example communication device 100, which may be configured to implement one or more of the example features described herein. As shown in FIG. 1, the communication device 100 includes a central processing unit 102, a memory 104, a network interface 106, a volatile storage 308, and input/output interfaces 110.

The memory is configured to store instructions executable by the central processing unit 102 to implement one or more applications 112, and an operating system 114. The communication device 100 may be configured to communicate over a network, e.g., a distributed communications infrastructure such as a local area network (LAN), a wide area network (WAN), the Internet, a corporate Intranet, a wireless network, a cellular network, etc., via the network interface 106.

### Communication Signal Synchronization

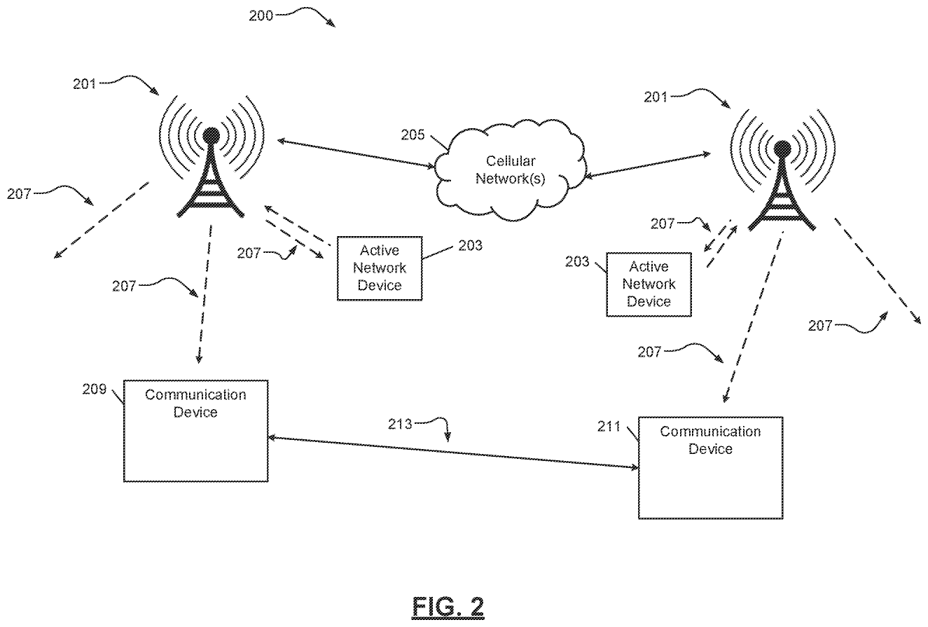

FIG. 2 illustrates an example system 200 including a first communication device 209 and a second communication device 211 (which each may be similar to the communication device 100 of FIG. 1). As shown in FIG. 2, the system 200 includes multiple signal antennas 201. The signal antennas 201 may include any suitable device for transmitting wireless signals, such as cellular towers, communication infrastructure devices, etc.

The signal antenna 201 may communicate with one another via one or more cellular networks 205. For example, each signal antenna may communicate with one or more active network devices 203, to relay signals between two active network devices 203 via the cellular network(s) 205. Although a cellular network arrangement is illustrated in FIG. 2, example embodiments are not limited thereto.

As shown in FIG. 2, each signal antenna 201 broadcasts or transmits an outbound signal 207, which may be received by other devices. For example, the active network devices 203 may receive the outbound signals 207 from the signal antennas 201 for communication with the signal antennas 201. The active network devices 203 may receive the outbound signals 207 and respond by sending their own signals back to the signal antennas for bidirectional communication between the active network device 203 and a signal antenna 201, as shown by two directional arrows representing wireless signals in FIG. 2.

The outbound signals 207 may include one or more parameters that can be used for synchronizing communications. For example, each signal antenna 201 may be synchronized to a same time as other signal antennas 201, a same frequency as other antennas, etc. The outbound signals 207 may allow the active network devices 203 to synchronize their own transmissions based on time, based on frequency, etc.

As shown in FIG. 2, each communication device 209 and 211 may receive one or more of the outbound signals 207 from the signal antennas 201. For example, each communication device 209 and 211 may passively listen for or receive the outbound signals 207 from the signal antennas 201, without establishing active communication with the signal antennas 201. In various implementations, each communication device 209 and 211 may passively listen without the signal antennas 201 knowing that the communication devices 209 and 211 are receiving the outbound signals 207, without the communication devices 209 and 211 sending any transmissions to the signal antennas 201 or over the cellular networks 205, etc.

The communication devices 209 and 211 may use one or more parameters or characteristics of the outbound signals 207 to synchronize communication between the communication devices 209 and 211. For example, if the communication device 209 synchronizes its own time, frequency, etc. based on an outbound signal 207 received from the signal antenna 201 nearest to its location, and the other communication device 211 synchronizes its own time, frequency, etc. based on another outbound signal 207 received from another signal antenna 201 nearest to its location, the communication devices 209 and 211 can establish synchronized communication with one another (e.g., because the synchronization parameters or characteristics of the separate outbound signals 207 received from the separate signal antennas 201 should be the same or substantially the same).

In various implementations, the communication devices 209 and 211 may communicate with one another via a synchronized communication channel 213 that is separate from the cellular network(s) 205. In particular, the communication devices 209 and 211 may use synchronization parameters or characteristics of the outbound signals 207 to synchronize their own communication channel 213, without communicating with the signal antennas 201 and without joining the cellular network(s) 205.

In various implementations, the signal antennas 201 may be considered as having self-synchronized transmitters (e.g., such as 5G cellular network transmission towers). For example, telecommunication companies may deploy and operate signal towers that allow their subscribers (e.g., the active network devices 203) to remain synchronized by communicating and updating time and other parameters.

The communication devices 209 and 211 may operate as non-cooperative transmitters, by passively listening to information that is transmitted by the cellular transmission towers, even though the communication devices 209 and 211 are not associated with or subscribed to a telecommunications network (e.g., the cellular network 205). For example, commercial cellular telecommunication companies may provide service to subscribers that requires the cellular towers to continuously communicate with all of the local user equipment (e.g., the active network devices 203), by sending and receiving communication management parameters, location data, etc.

In some example embodiments, the communication devices 209 and 211 may need to synchronize one or more parameters in order to communicate with one another. Each communication device 209 and 211 may listen to various other devices in the network, such as 5G cellular towers that are synchronized with one another. However, the 5G cellular towers may not be aware that the communication devices 209 and 211 are listening to signals from the 5G towers.

In the above example, each communication device 209 and 211 may synchronize to the signals coming from 5G towers, which should cause the communication devices 209 and 211 to be synchronized with each other (e.g., because they are each listening to 5G tower signals that may be known to be synchronized with one another). The communication devices 209 and 211 may not communicate over the 5G cellular network, and may only obtain parameters from listening to signals from the 5G towers so the communication devices 209 and 211 can generate waveforms to communicate with one another in synchronization.

In various implementations, the communication devices 209 and 211 may use signals from the signal antennas 201 to synchronize with one another in frequency. In some cases, the communication devices 209 and 211 may be too small to have accurate enough internal clocks to synchronize frequencies, and the communication devices 209 and 211 may use passive, uncooperative signal capture from other devices in the network. For example, 5G towers may continuously send out signals to cellular phones to synchronize frequency and time for communication with the cellular phones, and the communication devices 209 and 211 may passively pull signals from different 5G towers to know that they will be synchronized with one another.

The communication devices 209 and 211 may receive the outbound signals 207 via any suitable interface, such as a wireless signal receiver antenna (e.g., a 5G receiver chain antenna). Although 5G network examples are described herein, other example embodiments are not limited thereto. As described further below, passive observation by the communication devices 209 and 211 may be used to obtain parameters for generating a signal environment map. In various implementations, encryption may be used for communication between the communication devices 209 and 211.

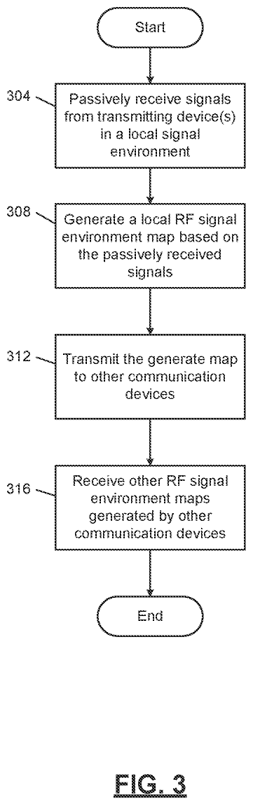

FIG. 3 is a flowchart depicting an example process for synchronizing communication between two communication devices, such as the communication devices 209 and 211. At 304, control begins by passively receiving a signal from a network signal antenna. Control then identifies at least one synchronization parameter (e.g., time synchronization, frequency synchronization, etc.) from the received signal at 308.

At 312, control sets an internal synchronization parameter of a communication device, such as a transmission time or frequency parameter, according to the signal received from the network signal antenna. Control then transmits a message to another communication device using the internal synchronization parameter, at 316.

### Signal Environment Mapping

In various implementations, one or more communication devices (such as the communication devices 209 and 211) may generate one or more maps of a radio frequency (RF) signal environment around the communication devices. For example, generating a map of the signal environment may allow the communication devices to identify available transmit channels and other parameters of a local signal environment in order to optimize communications between the devices.

Each communication device 209 and 211 may individually create a survey of its local RF environment and identify channels of interest based on existing signal types in that channel, emptiness of a channel, etc. Each communication device may share its knowledge of the local RF environment with other communication devices. For example, each communication device may share its own generate local RF environment map with other devices out of band, on an existing communications channel, etc., in order to share knowledge of the local RF environment from each device's perspective.

In some example embodiments, one or more of the communication devices may use knowledge from the shared map to determine optimal transmit and receive channels. This may include cases where there is only one receive and transmit channel, cases where multiple transmit and receive channels may be identified (e.g., for AMMO applications), etc.

Additional examples may include communication devices selecting optimal channels when multiple units are operating using a point-to-point method with single or multiple point to point links to/from each device, mesh network applications where multiple devices in the environment must be included in order to generate an optimal map to ensure service to all devices, etc. A list of optimal channels may be generated in situations where close or similar may create a risk of self-interference, and location and/or power may be taken into account during determination of the optimal transmit channels.

In further example embodiments, the communications devices may implement channel assignment where a centralized component (e.g., central device, central server, etc) directs optimal channel assignments to each communication device in the system. Alternatively, or in addition, optimal channel assignment determinations maybe distributed to each communication device, where each individual communication device is responsible for determining its own transmit channel using knowledge and input from other communication devices (e.g., based on local RF signal environment maps obtained from other communication devices).

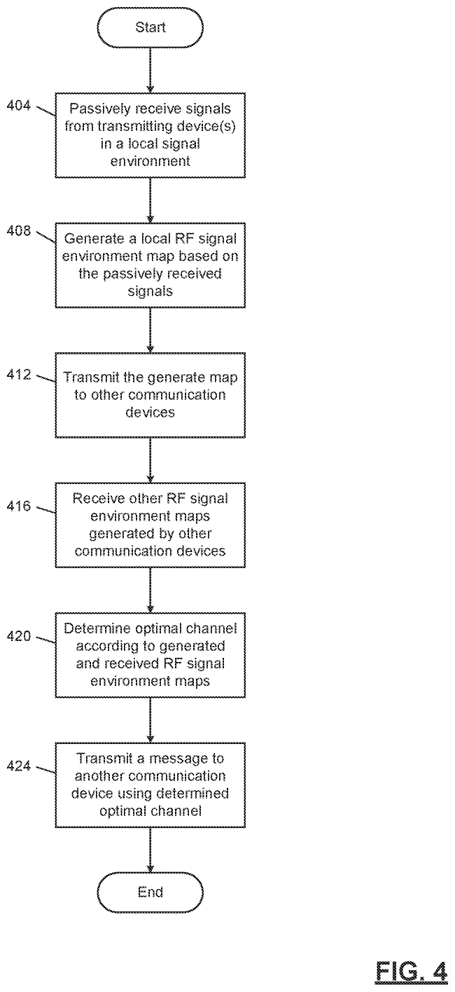

FIG. 4 depicts an example process for mapping an RF signal environment, which may be performed by, for example, the communication devices 209 and 211. At 404, control begins by passively receiving signals from one or more transmitting devices in a local signal environment. For example, the communication device 209 may receive outbound signals 207 from multiple signal antennas 201, without communicating with the signal antennas 201.

At 408, control generates a map of the local RF signal environment based on the passively received signals. At 412, control transmits its own generated map to at least one other communication device, and at 416 control receives at least one RF signal environment map generated by another communication device.

At 420, control determines an optimal channel according to at least its own generated RF signal environment map and the RF signal environment map received from another communication device. For example, control may identify an empty channel, a channel not having an existing conflicting signal type, etc. Control then transmits a message to another communication device using the determined optimal channel, at 424.

In various implementations, commercial telecommunications networks may send transmission parameters to user equipment as a function of network management. These parameters may be sent unencrypted. Communication devices may map a local frequency environment (e.g., to identify unused frequencies, unused channels, etc.), and share that information among nodes (e.g., other communication devices), in order to determine an improved or optimal bandwidth, power, etc.

In some example embodiments, each communication device may perform its own survey of the local RF signal environment around the device, and then share its survey results (e.g., a signal environment map) with other nodes (e.g., out of band, in a low bandwidth channel between devices, etc.), in order to collectively determine which device should use which channels, etc. For example, each communication device may search to identify available extra RE space that is available in their environment, after doing the local surveys and sharing the resulting information.

In some example embodiments, each communication device may use the shared signal environment information to agree on where and when each communication device is going to transmit signals in order to avoid interfering with one another, to avoid interfering with other devices and transmitters in the RF signal environment, etc. In some cases, one node (e.g., communication device) may act as a leader to determine optimal channels for each other communication device. Alternatively, a central device may be used to make optimal channel determinations for all communication devices.

As another example, each communication device may make its own optimal channel determination based on information from other communication devices. In this example, each communication device may randomize a selection and choose a channel, then inform other communication devices of the selected channel to avoid interference and resolve any conflicts.

### Wafeform Encryption

In various implementations, communication devices (such as the communication devices 209 and 211) may perform various methods of waveform encryption. Example waveform encryption methods may include out-of-band key exchange, pre-shared key exchange, in-band key rolling, etc.

Some example embodiments may include coded processing gain, where gain parameters, waveform hopping, frequency, bandwidth, etc. are pseudo-random based on, e.g., a cryptographic key. That cryptographic key may be shared out-of-band, may be pre-shared, etc.

In various implementations, the cryptographic key may be protected in transit and/or at rest, using public key encryption, encrypted content management (ECM) methods, etc. The key may be updated in-band with a new key, which may be protected using public key encryption, ECM encryption methodology where a key is changed to a newly shared key at a specified time or event, etc.

In some example embodiments, communication devices may receive data during periods of transmissions simultaneously from old and new keys, keys belonging to multiple transmitters, etc. As another example, in a mesh network where different groups of devices have different transmit keys, these keys may be shared individually to each receiver, or groups of receivers may be created for key sharing including situations where ECM user or group keying is implemented to share key information.

In various implementations, ECM implementations may roll and share keys used for waveform encryption. End user encryption and group encryption may be implemented, with regular exchanging and updating of keys. In some cases, the pattern of parameters may be changed periodically for communication between devices. As another example, some communication devices may use group keying, where even if multiple communication devices are on a same out-of-band channel, only people in the same ECM group may be able to access waveforms or communication transmission signals.

### CONCLUSION

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Similarly, one or more instructions stored in a non-transitory computer-readable medium may be executed in different order (or concurrently) without altering the principles of the present disclosure. Unless indicated otherwise, numbering or other labeling of instructions or method steps is done for convenient reference, not to indicate a fixed order.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements.

The phrase “at least one of A, B, and C” should be construed to mean a logical (A OR B OR C), using a non-exclusive logical OR, and should not be construed to mean “at least one of A, at least one of B, and at least one of C.” The term “set” does not necessarily exclude the empty set. The term “non-empty set” may be used to indicate exclusion of the empty set. The term “subset” does not necessarily require a proper subset. In other words, a first subset of a first set may be coextensive with (equal to) the first set.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include processor hardware (shared, dedicated, or group) that executes code and memory hardware (shared, dedicated, or group) that stores code executed by the processor hardware.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module. For example, the client module may include a native or web application executing on a client device and in network communication with the server module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. Such apparatuses and methods may be described as computerized apparatuses and computerized methods. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A system for synchronizing communication between devices, the system comprising:
a first cellular network antenna;
a second cellular network antenna in communication with the first cellular network antenna via a cellular network, each of the first cellular network antenna and the second cellular network antenna configured to broadcast outbound signals;
a first communication device configured to receive outbound signals broadcast by the first cellular network antenna; and
a second communication device configured to receive outbound signals broadcast by the second cellular network antenna, the first communication device and the second communication device configured to synchronize communication between one another according to at least one parameter of the received outbound signals.

2. The system of claim 1, wherein each of the first cellular network antenna and the second cellular network antenna is not configured to receive signals from the first communication device and the second communication device.

3. The system of claim 2, wherein the first communication device and the second communication device are configured to communicate with one another over a channel which is separate from the cellular network.

4. The system of claim 1, wherein the at least one parameter of outbound signals broadcast by the first cellular network antenna is in synchronization with the at least one parameter of outbound signals broadcast by the second cellular network antenna.

5. The system of claim 1, wherein:
the first cellular network antenna includes a self-synchronized transmitter; and
the second cellular network antenna includes a self-synchronized transmitter.

6. The system of claim 5, wherein:
the first cellular network antenna is a 5G cellular network antenna;
the second cellular network antenna is a 5G cellular network antenna; and
the cellular network is a 5G cellular network.

7. The system of claim 1, wherein:
the first communication device is configured to set an internal synchronization parameter of the first communication device, for communication with the second communication device, according to the at least one parameter of the received outbound signals; and
the second communication device is configured to set an internal synchronization parameter of the second communication device, for communication with the first communication device, according to the at least one parameter of the received outbound signals.

8. The system of claim 7, wherein the internal synchronization parameter of the first communication device is a communication frequency parameter for communication with the second communication device.

9. The system of claim 7, wherein the internal synchronization parameter of the first communication device is a communication time parameter for communication with the second communication device.

10. The system of claim 1, wherein the first communication device is configured to survey of a radio frequency (RF) environment of the first communication device to create an RF environment map of the first communication device.

11. The system of claim 10, wherein the first communication device is configured to identify at least one channel of interest according to at least one of an existing signal type of each channel in the RF environment map or an emptiness of each channel in the RF environment map.

12. The system of claim 10, wherein the first communication device is configured to transmit the RF environment map to the second communication device.

13. The system of claim 12, wherein the second communication device is configured to determine at least one optimal transmit channel or receive channel for communication between the first communication device and the second communication device.

14. The system of claim 1, wherein the first communication device is configured to perform at least one waveform encryption method for communicating with the second communication device.

15. The system of claim 14, wherein the at least one waveform encryption method includes at least one of an out-of-band key exchange, a pre-shared key exchange, or in-band key rolling.

16. A method for synchronizing communication between devices, the method comprising:
broadcasting outbound signals by a first network antenna;
broadcasting outbound signals by a second network antenna in communication with the first network antenna;
receiving, by a first communication device, outbound signals broadcast by the first network antenna;
receiving, by a second communication device, outbound signals broadcast by the second network antenna; and
synchronizing communication between the first communication device and the second communication device according to at least one parameter of the received outbound signals.

17. The method of claim 16, wherein synchronizing communication includes communicating between the first communication device and the second communication device over a channel which is separate from a communication network for communication between the first network antenna and the second network antenna.

18. The method of claim 17, wherein the at least one parameter of outbound signals broadcast by the first network antenna is in synchronization with the at least one parameter of outbound signals broadcast by the second network antenna.

19. The method of claim 16, further comprising:
setting an internal synchronization parameter of the first communication device, for communication with the second communication device, according to the at least one parameter of the received outbound signals; and
setting an internal synchronization parameter of the second communication device, for communication with the first communication device, according to the at least one parameter of the received outbound signals.

20. The method of claim 19, wherein the internal synchronization parameter of the first communication device is a communication frequency parameter or a communication time parameter for communication with the second communication device.
